(19) United States
(12) Patent Application Publication
(10) Pub. No.: US 2010/0302322 A1
(43) Pub. Date: Dec. 2, 2010

(54) MICROMACHINED FLUID EJECTOR

(75) Inventor: Mark Y. Wang, Fremont, CA (US)

Correspondence Address: QUINE INTELLECTUAL PROPERTY LAW GROUP, P.C., P O BOX 458, ALAMEDA, CA, 94501, US

(73) Assignee: MicroPoint Bioscience Inc.

(21) Appl. No.: 12/450,591

(22) PCT Filed: Mar. 28, 2008
(86) PCT No.: PCT/US08/04074

§ 371 Date: Apr. 22, 2010

(30) Foreign Application Priority Data
Mar. 31, 2007 (US) 11694943

(51) Int. Cl. B41J 2/045

(52) U.S. Cl. 347/68

(57) ABSTRACT

This invention relates to micromachined fluid ejector arrays having a fluid reservoir bounded at one side by an elastic membrane having scalable arrays of orifices arranged between concentric piezoelectric transducers, and bounded at another side by a top cover supported by surrounding walls. By actuating neighboring concentric piezoelectric transducers, the scalable array of orifices arranged between the actuated neighboring concentric piezoelectric transducers deflect to eject fluid droplets. Also disclosed is a micromachined fluid ejector array having a fluid reservoir bounded at one side by an elastic membrane having scalable arrays of orifices arranged between concentric piezoelectric transducers, and at another side by a top cover supported by surrounding walls with a piezoelectric layer bonded on top of the top cover. By actuating the piezoelectric layer, the scalable arrays of orifices arranged between the neighboring concentric piezoelectric transducers deflect in phase to eject fluid droplets.

### CROSS-REFERENCE TO RELATED APPLICATIONS

This application claims priority to and benefit of a prior U.S. Utility application Ser. No. 11/694,943, Micromachined Fluid Ejector, by Yunlong Wang, filed Mar. 31, 2007. The full disclosure of the prior application is incorporated herein by reference.

### FIELD OF THE INVENTION

The inventions are in the field of fluid ejector arrays useful in assay methods and assay devices. Devices include a membrane with nozzles between concentric transducers, with the membrane mounted between a fluid reservoir and cavity. Actuation of the transducers can flex the membrane causing fluid to be ejected from the reservoir into the cavity. Particular methods are directed to analyte analysis wherein a reacted analyte is ejected from an array of orifices onto a surface for detection. The devices can include a reaction chamber in fluid contact with an ejector array over a cavity for ejection of reaction products onto a surface for capture and/or detection.

### BACKGROUND OF THE INVENTION

In the microfluidic field, many issues are encountered in fluid handling. Certain forces, such as surface tension and electrostatics become relatively important in microscale devices. Issues, such as, fluid dispersion, dead volume minimization, accurate fluid volume delivery, and flow control, need to be addressed in novel ways. Current microfluidic handling techniques may not be suitably tailored to the unique problems encountered in microfluidic analyses.

Fluid droplet ejectors are commonly associated with the business of printing. Nozzles of various kinds have been reported in many publications and are commercially available. These nozzles are typically used to allow the formation and control of small ink droplets that result in high quality printing on demand. Typically, an ink printhead has apertures or nozzles from which ink droplets are expelled onto a print medium, and the ink is routed internally through the printhead. Conventional methods of ejecting inks onto the print medium include piezoelectric transducers and bubbles formed by heat pulses to force fluid out from the nozzles. In situations where a printhead includes multiple nozzles, if one desires to selectively expel ink droplets from a specific nozzle and not the other nozzles, conventional solutions known in the art require the nozzles to be isolated from each other by long narrow passages that damp pressure surges in the ink fluid provided to the nozzles from a common source. Heaters can also be located at each nozzle, for the purpose of reducing ink viscosity at a specific nozzle. Thus, when a droplet is to be ejected from a specific nozzle, the heater at that nozzle is activated to heat ink at the nozzle so that when a pressure pulse is applied to the ink fluid, the ink viscosity at the nozzle is reduced enough so that a droplet of ink will be expelled from the nozzle, while the higher viscosity of the (colder) ink at the other nozzles remains high enough to prevent ejection of ink droplets from those other nozzles.

In U.S. Pat. No. 6,712,455, to Dante, a printhead is provided with a common ink chamber or reservoir bounded on one side by a membrane having nozzle apertures. The membrane forms a print face of the printhead. Piezoelectric elements (piezos) are located on the membrane near the nozzles. The piezos flex segments of the membrane surrounding the nozzles to eject ink droplets from individual nozzle apertures. Ribs are also provided on the membrane and define boundaries of the membrane segments corresponding to the nozzles. The ribs can isolate each nozzle from the other nozzles, in two ways. First, the ribs act as stiffeners so that when piezos attached to one membrane segment flex that membrane segment, the other membrane segments are not significantly flexed. Second, the rib walls on an interior surface of the membrane deflect the pressure pulse upwards in the actuated membrane segment, and away from adjacent membrane segments/nozzles.

Micromachined droplet ejectors have also been reported in U.S. Pat. Nos. 6,445,109 and 6,474,786 to Perçin, et al. These types of droplet ejectors include a cylindrical reservoir closed at one end with an elastic membrane including at least one aperture and a bulk actuator at the other end for actuating the fluid for ejection through the aperture. The ejector array is a micromachined two-dimensional array droplet ejector. The ejector includes a two-dimensional matrix array of elastic membranes having orifices closing the ends of cylindrical fluid reservoirs. The fluid in the ejectors is bulk actuated by pressure waves in the fluid, which causes fluid to form a meniscus at each orifice with nearly enough energy to escape the orifice. Actuation of peizo transducers at specific membrane locations can then selectively eject droplets from individual orifices. In an alternative mode of operation, the bulk pressure wave has sufficient amplitude to eject droplets while the individual membrane transducers are actuated to selectively prevent ejection of droplets from specific orifices.

These conventional and micromachined print heads or fluid ejectors suffer from various disadvantages, particularly in realm of microfluidic devices. First, they usually require a large interconnected reservoir to store the ink or fluid. The fluid can only be ejected when this reservoir is fully filled, which usually results in large waste because these are considered dead volume. Second, the print head or ejector array has many long, narrow passages for transmitting ink to a particular nozzle. Third, many of these print heads and fluid ejectors are specialized for selective fluid ejection from one particular nozzle, but are not well tailored to providing uniform spray from multiple nozzles. In addition, these ejectors are not well suited to uniformly eject fluid in pico-liter quantities typical of microfluidic devices.

In view of the above, a need exists for fluid ejectors that can control fluid ejection at pico-liter level reliably for biochemical and or diagnostic assay applications. It would be desirable to have devices with fluid ejectors having smaller compartmental dead volume to more efficiently deal with small sample sizes and expensive reagents. In addition, it would be beneficial to realize fluid ejectors that eject fluid droplets uniformly across multiple orifices, e.g., without satellite drops. The present invention provides these and other features that will be apparent upon review of the following.

### SUMMARY OF THE INVENTION

The present invention includes methods and devices using fluid ejector arrays, e.g., to disperse assay reaction products onto a surface for capture or detection. The devices can comprise a reaction chamber in fluid contact with a fluid ejector array. The array of ejectors can be positioned over a cavity having a capture surface floor. The ejectors can uniformly disperse reaction products of the reaction chamber onto the capture surface for capture and/or detection. The methods of the invention can include introducing sample analytes to assay reagents on one side of an ejector array and ejecting reaction products onto a surface on the other side of the array for detection.

It is an object of the present invention to provide a micromachined fluid ejector array suitable for employment in microfluidic assay chips. It is another object of the present invention to provide a micromachined fluid ejector array that has a smaller dead volume. It is a further object of the present invention to provide a micromachined fluid ejector array that comprises a concentric array of piezoelectrically actuated flextensional transducers.

In another object of the present invention, a micromachined fluid ejector array is provided comprising a concentric array of piezoelectrically actuated flextensional transducers. A scalable array of orifices are filled between neighboring concentric flextensional transducers. By actuating these neighboring transducers, the scalable array of orifices eject fluid droplets. It is further an object of the invention to provide a micromachined fluid ejector array comprising a concentric array of piezoelectrically actuated flextensional transducers, with neighboring concentric flextensional transducers separately ejectable or with all flextensional transducers configures for actuation to eject fluid droplets from all orifices at once. It is a further object of the present invention to provide a micromachined fluid ejector array having a fluid reservoir that is bounded by a flextensional membrane at one end so that the membrane can be piezoelectrically actuated to eject fluid drops. It is another object of the present invention to provide a micromachined fluid ejector array fluid reservoir that is bounded on the other end by a cover with a bulk actuator, e.g., of piezoelectric material, whereby electrical actuation of the piezoelectric material causes an associated fluid ejector array to eject fluid droplets from all orifices in phase.

The foregoing objects, and other objects of the invention, can be achieved by a micromachined fluid ejector array that is bounded by a flextensional membrane that is electrostatically deformable at one end and a cover at the other end. A piezoelectric actuator layer can be bonded on top to a top cover. A concentric array of piezoelectric transducers can be arranged on the flextensional membrane. The scalable array of orifices, can be photolithographically applied to the flextensional membrane. Actuating neighboring concentric piezoelectric transducers can eject fluid droplets from orifices spaced between these transducers. Actuating all concentric piezoelectric transducers at once can make all orifices eject fluid droplets, e.g., according to a driving frequency. Actuating a piezoelectric transducer layer bonded on top of the top cover makes all orifices eject fluid droplets in phase.

The devices of the invention include, e.g., micromachined fluid ejectors comprising a membrane with two or more concentric piezoelectric transducers, and two or more nozzle channels through the membrane positioned between the two or more concentric transducers. There is typically a fluid reservoir on a one side of the membrane and a cavity on the other side of the membrane. The nozzles are typically not isolated from each other by ribs (e.g., partitions or walls) on the fluid reservoir side of the membrane, as this is not necessary to the usual function of the device. The reservoir can include a cover aligned parallel to the membrane and comprising a bulk actuator, such as, e.g., a piezoelectric actuator, a piezoresistive actuator, an electrostatic actuator, a capacitive actuator, a magnetostrictive actuator, a thermal actuator, a pneumatic actuator, and/or the like.

The methods of the invention include, e.g., microfluid ejection by providing a membrane comprising two or more concentric piezoelectric transducers with two or more nozzles positioned between, providing a reservoir of fluid on a first side of the membrane, and applying an electric voltage to one or more of the transducers to deflecting one or more of the nozzles to eject one or more droplets of the reservoir fluid from the one or more nozzles. Ejection can be accomplished by, e.g., applying electric voltage to the two or more piezoelectric transducers at once. The methods can include providing a reservoir cover with a bulk actuator and aligned parallel to the membrane, and actuating the bulk actuator, e.g., to eject droplets of fluid or prestage the fluid in the nozzles for ready ejection of transducer activation. For example, in some embodiments, activating the bulk actuator generates of a bulk pressure wave with an amplitude large enough to eject droplets from two or more of the nozzles at once.

### DEFINITIONS

Unless otherwise defined herein or below in the remainder of the specification, all technical and scientific terms used herein have meanings commonly understood by those of ordinary skill in the art to which the present invention belongs.

Before describing the present invention in detail, it is to be understood that this invention is not limited to particular devices or biological systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content clearly dictates otherwise. Thus, for example, reference to “a component” can include a combination of two or more components; reference to “fluid” can include mixtures of fluids, and the like.

Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

As used herein the terms “orifice” and “nozzle” refer to fluid channels or holes through the membrane from which droplets of fluid can be ejected on actuation of membrane transducers and/or bulk actuators of the invention.

The term “ribs” refers to raised partitions on the fluid reservoir side of a membrane of the invention.

The term “transducer” refers to a device or material that converts an input energy to motion or force. For example, a piezoelectric transducer can convert an input electric voltage into a mechanical force or force over a distance, e.g., to flex, vibrate or contract an associated membrane.

The term “concentric” in the context of the present inventions refers to a condition, e.g., in which a transducer surrounds another transducer on a membrane. In many cases, the geometric center or center of mass is substantially the same for the two or more “concentric transducers”. For example, the centers can be exactly the same or the center of the surrounding transducer can be within the boundaries of inner transducer.

### BRIEF DESCRIPTION OF THE DRAWINGS

The foregoing and other objects of the invention will be more clearly understood from the following description when read in conjunction with the accompanying drawings of which:

FIG. 1 is a cross-sectional view schematic diagram of a micromachined fluid ejector array according to one preferred embodiment of the present invention. For example, FIG. 1 can represent a cross-section through the ejector of FIG. 4.

FIG. 2 shows a cross-sectional view of a micromachined capacitive fluid ejector array along the line A-A′ in FIG. 4 according to another preferred embodiment of the present invention.

FIG. 3 is a cross-sectional view schematic diagram of a micromachined fluid ejector array according to one preferred embodiment of the present invention, including a bulk actuator mounted to a reservoir cover.

FIG. 4 shows a top plane view of a micromachined fluid ejector array on a membrane, including concentric transducer rings with nozzles therebetween, according to one preferred embodiment of the present invention.

FIG. 5 shows a cross-sectional view of fluid ejection a micromachined fluid ejector array according to one preferred embodiment of the present invention. Actuation of radial concentric transducers selectively ejects fluid droplets at once from two nozzles into a cavity.

FIG. 6 shows a cross-sectional view of fluid ejection a micromachined fluid ejector array according to another preferred embodiment of the present invention. Actuation of a bulk actuator causes ejection of fluid droplets from all nozzles at once.

### DETAILED DESCRIPTION

A fast, reliable method for dispensing microliter, nanoliter, picoliter or femtoliter fluid volumes is needed in many emerging areas of biomedicine and biotechnology. There is also a continuing need for alternative deposition techniques of organic polymers in precision droplet-based manufacturing and material synthesis, such as the deposition of doped organic polymers for organic light emitting devices of flat panel displays, and the deposition of low-k dielectrics for semiconductor manufacturing. A reliable and low-cost droplet ejector array is needed that can supply high quality droplets, e.g., uniform droplet size and ejection without satellite droplets, at high ejection frequencies and high spatial resolutions.

The present inventions include methods and devices for microejection of fluid droplets. The devices generally comprise a flexible membrane with concentric rings of motion transducers surrounding a radial array of fluid ejection orifices. The methods generally comprise provision of a device with concentric transducer rings surrounding fluid ejection orifices and actuating the transducers to move the membrane and force fluid droplets out from the orifices.

### Microdroplet Ejecting Devices

A microejection device of the invention can include, e.g., a membrane mounted between a fluid reservoir and a cavity. The membrane can have orifices (e.g., nozzles) between concentric transducers (e.g., piezoelectric rings). The fluid reservoir can be further enclosed with a cover and can receive one or more fluids through input channels. The cover can include a bulk actuator to energize the fluid in bulk.

The membranes of the invention are, e.g., a sheet of material including motion transducers and orifices. The membranes are typically mounted in a device between a covered fluid reservoir and a cavity into which fluid droplets are ejected. The membranes are typically not totally rigid, but are functionally flexible enough to interact with transducer forces in the task of ejecting droplets.

The fenestrated membrane is preferably formed from, e.g., silicon nitride or silicon. However, it can be fabricated of other thin, flexible materials, such as plastic, glass, metal or other material that is preferably not reactive with the fluid to be ejected.

The membrane can range in thickness from about 1 mm to about 0.1 μm, from about 0.5 mm to about 1 μm, from about 0.25 mm to 0.05 mm, or about 0.1 mm. The membranes are typically planar with length and width dimensions ranging from about 20 mm to about 1 mm, from about 10 mm to about 2 mm, from about 7 mm to about 3 mm, or about 4 mm. The membrane can have a convex or concave shape, but is preferably planar when at rest (e.g., without actuator or transducer activation).

The membranes have at least one orifice running from the reservoir side of the membrane to the cavity side of the membrane. In preferred embodiments, the membrane has more than 2 orifices, 4 or more orifices, 7 or more orifices, 25 or more orifices, 57 or more orifices, or 100 or more orifices. The orifices are typically arranged in a radial pattern between two or more concentric transducers on the membrane; often, there is one orifice within the inner transducer ring. Optionally, the orifices can be arranged in other geometric patterns between the transducers. Typically, the thickness of the membrane can be small in comparison to the droplet (orifice size), which results in break-up and pinch-off of the ejected droplets from the air-fluid interface.

The diameters of the orifices, e.g., where they penetrate the cavity side of the membrane, can all be the same, or can vary. The diameter of the orifices can range, e.g., from 2 mm or more to about 0.1 μm or less, from about 0.5 mm to about 1 μm, from about 0.25 mm to 0.05 mm, or about 0.1 mm. The diameters can be established empirically, and/or through calculation, to provide the ejection timing, droplet size and threshold ejection energy desired for a particular application. In one embodiment, flexion of the membrane at the center is greater than at peripheral locations, so the more central orifices have a smaller diameter than peripheral orifices in order to obtain consistent droplet ejection from all orifices.

Transducers are typically incorporated into or onto the membrane in a pattern of concentric rings with nozzle spaces between. Optionally, the concentric transducers can be patterned with other shapes, such as, e.g., wavy rings, squares, ovals, rectangles, etc. suitable to a particular application and overall membrane or cavity shape.

Concentric transducers of the membrane can be any type, but piezoelectric transducers are preferred for their simplicity, responsiveness and ease of manufacture. The transducers can be mounted on the reservoir side of the membrane, cavity side of the membrane, and/or embedded within the membrane. In response to a voltage, the piezoelectric transducers can expand or contract in one or more dimensions. For example, a ring transducer can expand along its central axis, in response to a voltage, to increase the overall diameter of the ring. Optionally, the transducer can change in a dimension perpendicular and/or parallel to the plane of the membrane to induce a motion in the membrane. In response to the transducer changes in dimensions, standing waves can be induced in the membrane, flexion can be induced in a selected region of the membrane surface, or the whole membrane can move in the same direction to flex uniformly at once. For piezoelectric transducers, electric leads can be provided, e.g., running on the opposite side of the membrane, within the membrane, or on the same side of the membrane, with appropriate insulation.

The transduced and perforated membranes are typically part of an assemblage providing a device with a liquid fluid reservoir on one side of the membrane and a gas (e.g., air) filled cavity on the other side. In a typical embodiment, the membrane is mounted at peripheral edges into a framework including, e.g., the enclosing structures of the liquid reservoir on one side and the cavity side walls on the other side. For example, the membrane periphery can be held as a layer between the side walls of the fluid reservoir and the side walls of the cavity. In certain embodiments, the side walls of the cavity can be part of a device substrate, e.g., which also includes other micromachined components of an overall working device. Although a silicon substrate or body having a cavity has been described, it is clear that the substrate or body can be other types of semi-conductive material, plastic, glass, metal or other solid material in which cylindrical reservoirs can be formed.

The cavity, into which droplets are ejected, is typically below the membrane, so that ejected droplets can fall away from the membrane. However, in some embodiments, the cavity can be above or to the side of the membrane, in relation to a gravitational field. The cavity can be all, or a part of, any space requiring the ejected droplets. For example, the cavity can be a combustion chamber, a space between an ink jet and printing paper, a semiconductor deposition chamber, or a chamber in a bioassay chip.

The fluid reservoir is typically above the membrane, e.g., so the fluid is directed by gravity to functionally contact the reservoir side of the membrane. Optionally, the reservoir is not directly above the membrane, but is filled with a liquid fluid so that no gas bubbles contact the orifices. One or more channels typically lead to the reservoir to bring desired fluids (e.g., samples, inks, reaction products, fuel, etc.) to the reservoir. The reservoir typically has a greater dimension parallel to the membrane than perpendicular to the membrane, e.g., to minimize volumes and increase responsiveness to bulk pressure waves. In many embodiments, the reservoir wall across from the membrane is a rigid (or, optionally, semi-rigid or flexible) cover. The cover can include a bulk actuator to induce bulk pressure waves into the fluid, as desired.

Fluids in the fluid reservoir can be any desired for a particular application of the fluid ejector. Typical fluids for ejection in the devices of the invention include, e.g., ink, fuel, biological samples, assay reagents, inorganic elements or salts, semiconductors, and/or the like. Typically, the fluid is an aqueous solution or suspension. Optionally, the “fluid” can be in other solvents, or even a suspension of dry powder particles. The devices of the invention can work with fluids having a wide range of viscosities to provide ejected droplets ranging is volume from about 10 μL to 10 femtoliters, 1 μL to 1 picoliter, from 0.1 μL to 1 nanoliter, or about 10 nanoliters.

Optionally, one or more bulk actuator can be associated with the fluid reservoir, e.g., to induce pressures or pressure waves into the fluid. The actuators can be any suitable to apply a force on the reservoir surface to change the reservoir volume and/or change the pressure of the reservoir fluid. For example, the bulk actuator can be a piezoelectric actuator, a piezoresistive actuator, an electrostatic actuator, a capacitive actuator, a magnetostrictive actuator, a thermal actuator, a pneumatic actuator, and/or the like. In one embodiment, the bulk actuator is a piezoelectric layer mounted to the reservoir cover.

### Methods of Ejecting Microdroplets

Droplets of fluid can be ejected from a reservoir on one side of a membrane through orifices between concentric transducers into a cavity on the other side of the membrane, when the transducers are energized. The methods can include provision of the inventive devices, with two or more nozzles between two or more concentric transducers on a membrane, provision of a fluid in a reservoir on one side of the membrane, and energizing at least one of the transducers to deflect the membrane so that pressure and/or momentum cause one or more droplets of the fluid to be ejected from the other side of the membrane into a cavity. The fluid droplets can then interact with gasses in the cavity or come into contact with a surface on the other side of the cavity.

Devices can be provided, as described above. In a typical embodiment, the device is fabricated in layers by sequential etching, deposition and/or application of materials and structures (e.g., micromachined). For example, a substrate with a cavity can be molded from a plastic or etched from a silicon blank. The membrane can be applied over the substrate and cavity. Channels and walls of the fluid reservoir can be deposited through a mask, or applied over the membrane, e.g., using an adhesive. A top cover can be applied to seal the fluid reservoir.

Fluids can be introduced into the fluid reservoir using any suitable means. For example, the fluid reservoir can be filled, through an input channel, by capillary action, application of external pressure to the fluid, flow by gravity, application of a relative vacuum at an outlet channel, and the like.

Combinations of membrane layouts and transducer actuation patterns can provide a variety of useful droplet ejection results. For example, in one embodiment, the two or more concentric transducers can be energized at once to uniformly flex the entire membrane to inject droplets from all orifices at once. In other embodiments, adjacent pairs of concentric transducers can be energized at the same time to induce flexion in the membrane in between so that only those orifices between the two energized transducers eject droplets. In still other embodiments, the two or more transducers can be energized in a pattern that results in waves or ripples across the membrane, resulting in a corresponding pattern of droplet ejections from the orifices.

In many embodiments, a bulk actuator can be useful in prestaging ejections or in simultaneous ejections from multiple orifices. For example, a bulk actuator can be activated to flex a reservoir cover to provide a pressure in the reservoir fluid. The pressure can cause fluid ejection from orifices, or prestage fluid in the orifices at a pressure just below a pressure at which surface tension would be overcome. Such prestaging can allow droplets to be ejected more energetically and/or more promptly in response to membrane transducer activation.

In many embodiments, the ejected fluid droplets come into contact with a surface in the cavity. The devices can eject fluids, such as, e.g., liquids, suspensions, small solid particles and/or gaseous phase materials. Most typically, the fluid ejected is a liquid. The droplet ejector can be used for inkjet printing, biomedicine, drug delivery, drug screening, fabrication of biochips, fuel injection and semiconductor manufacturing. For example, the fluid can be an ink and come into contact with printing paper, e.g., to become part of a printed text or image. In other embodiments, the droplets can contact a substrate, e.g., through openings in a mask, to deposit semiconductor materials, or structural materials onto the substrate.

The fluids can be ejected onto a reaction and/or detection surface of a chemical or biomedical assay device. For example, the fluid can be a mixture of a sample analyte and a reagent that includes a reaction product. The reaction product can be ejected to contact a surface at the bottom of the cavity where the reaction product can be detected (e.g., by light absorbance or fluorescence) before flowing out of the cavity through a waste channel. Optionally, the fluid can be a sample, uniformly ejected onto the surface where sample analyte is captured or reacted with a reagent.

### EXAMPLES

The following examples are offered to illustrate, but not to limit the claimed invention.

### Example 1

### Microfluidic Ejector with Concentric Transducers

A droplet ejector was designed to have maximum displacement between neighboring concentric piezoelectric transducers on a membrane. The vibrating membrane has a scalable array of orifices arranged between the neighboring concentric piezoelectric transducers. These transducers are actuated in pairs so that the orifices arranged between them will vibrate to eject fluid droplets. Longitudinal thickness mode piezoelectric materials are used as an actuation mechanism. In this case, all orifices on the membrane will eject the fluid droplets in phase when all the transducers are activated.

The concentric piezoelectric transducers set up capillary waves at the liquid-air interface and raises the pressure in the liquid above atmospheric (as high as 1.5 MPa) during part of a cycle, and if this pressure rise stays above atmospheric pressure long enough with adequate pressure, fluid inertia and surface tension can be overcome to eject drops from one or more orifice of the membrane. If the plate displacement amplitude is too small, the meniscus in the orifice may simply oscillate up and down without ejection of a fluid droplet. If the frequency is too high, the pressure in the fluid may not remain above atmospheric long enough to eject a drop.

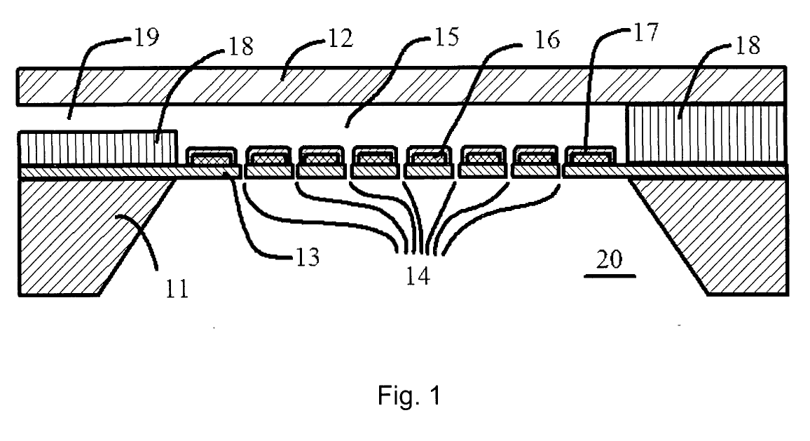

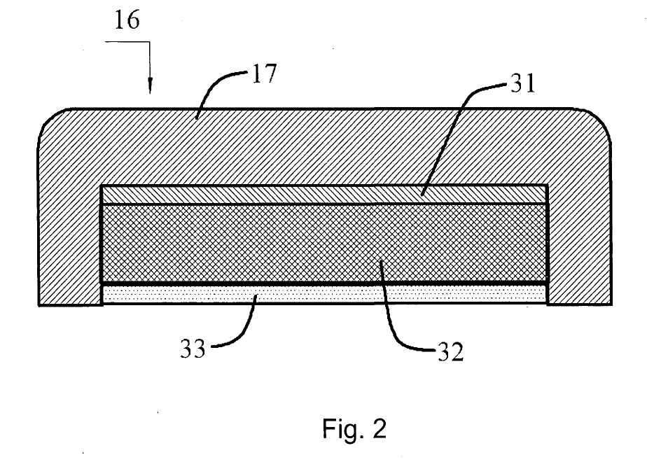

FIG. 1 presents a cross-sectional view of a micromachined fluid ejector array according to the preferred embodiment of current invention. The ejector array comprises an elastic membrane 13 supported by the silicon substrate 11 and has a scalable (functionally variable) number of orifices 14 arranged in a pattern through the membrane surfaces. On top of the membrane 13, there are evenly spaced piezoelectric transducers 16 (concentric in the depth dimension). The piezoelectric transducers 16 include a piezoelectric layer 32 coated with top electrode 31 and bottom electrode 33, as shown in FIG. 2. An isolation layer 17 is coated on top of the top electrode 31 to prevent the electrode from making direct electrical contact with the fluid that is to be ejected. The elastic membrane 13 can be conductive, e.g., to act as a common electrode (e.g., ground) for transducers 16. One side of elastic membrane 13 provides a boundary of fluid reservoir 15. The fluid reservoir 15 can store fluid to be ejected, and is further bounded by sidewalls 18 and a top cover 12. A fluid inlet 19 is provided at one end of sidewall to allow the fluid to be introduced into the reservoir 15. Both sidewall 18 and top cover 19 can be made of plastics, PDMS, acrylics or other non-conductive materials, and bonded to the micromachined silicon base. The sidewall 18 and top cover 19 can optionally be micromachined by sacrificial etching. Cavity 20 can be formed by etching away a part of bulk silicon during the micromachining.

### Example 2

### Bulk Energization of Fluids

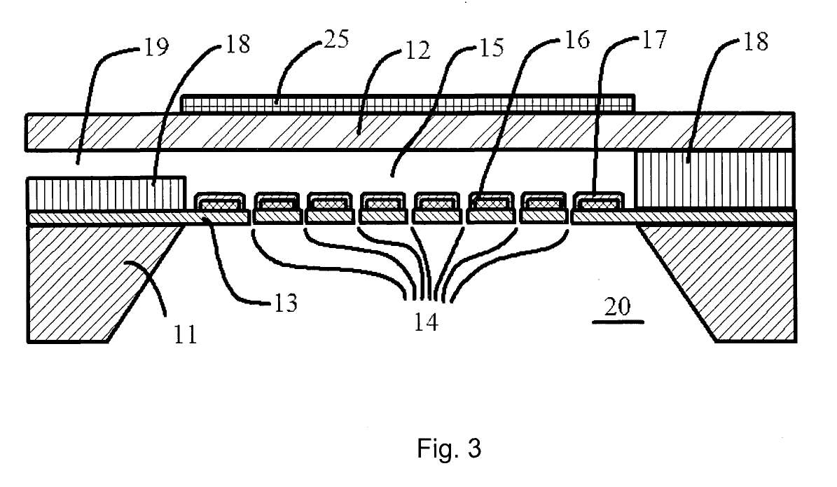

In another preferred embodiment, as shown in FIG. 3, a bulk actuator layer 25 is bonded to the top cover 12, e.g., to induce bulk pressure waves into the fluids in the reservoir. In this example, piezoelectric bulk actuator layer 25 can vibrate transflexurally to cause the top cover 12 buckle up and down.

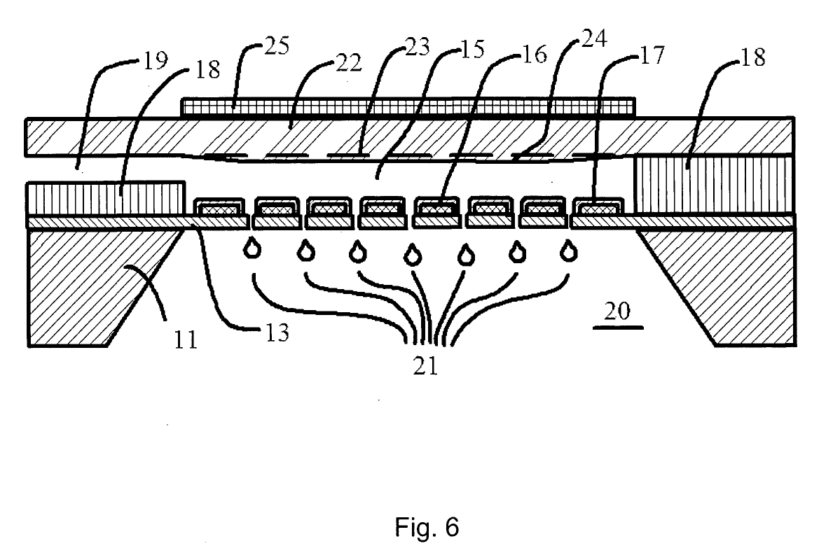

In one mode of operation, the bulk actuation waves can have an amplitude large enough to eject fluid droplets through orifices 14 in phase, even without actuation of the membrane piezoelectric transducers, as shown in FIG. 6. The bulk actuation wave is generated by applying electric signals on piezoelectric layer 25. The alternating electric signal causes the top cover 12 to alternately oscillate up and down (position 24). The oscillations of top cover 12 generate bulk pressure waves in fluid inside the reservoir 15. If this bulk pressure is large enough, e.g., to overcome the capillary forces that keep fluid in the orifices 14, the droplets 21 will be ejected from orifices 14.

Bulk actuators can be piezoelectric, piezoresistive, electrostatic, capacitive, magnetostrictive, thermal, pneumatic, etc. Piezoelectric, electrostatic, magnetic, capacitive, magnetostrictive actuation, can optionally be employed in actuation for the membrane transducer array elements. Thickness mode piezoelectric actuators in either longitudinal or shear mode can be used for bulk actuation: Single or multiple (i.e. arrays of) thickness mode piezoelectric actuators can be used for the bulk actuation. The actuation of the original array elements can be performed by selectively activating the concentric piezoelectric transducers 16 associated with the array of orifices 14 to act as a switch to either turn on or turn off the ejection of drops. The meniscus of the orifice can always vibrate (while remaining below an ejection threshold), e.g., to decrease transient response and/or to decrease drying of the fluid and prevent self-assembling of the fluid ejected near the orifice. Excitation frequencies of bulk and individual array element actuations can be the same or different depending upon the application.

### Example 3

### Selective Election of Droplets

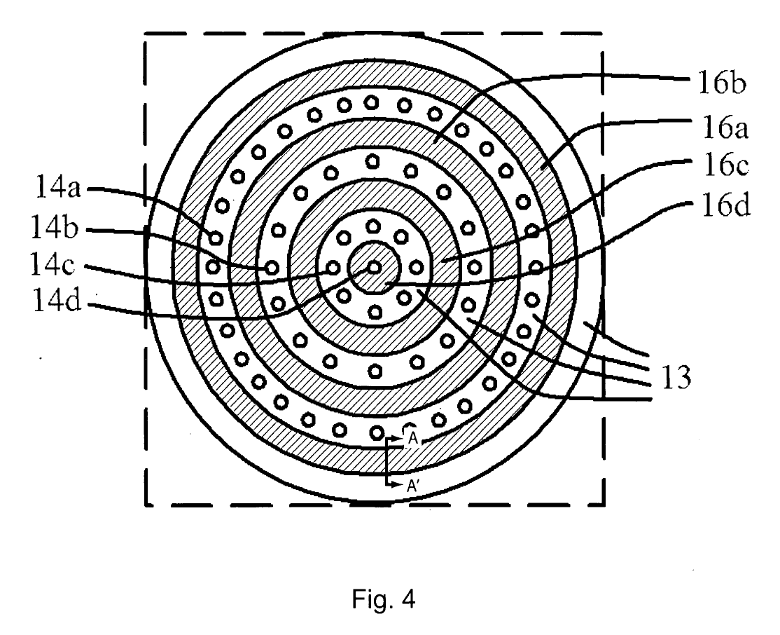

Selective or sequential actuation of membrane transducers and/or cover actuators can result in ejection of droplets from orifices in a non-uniform pattern. FIG. 4 shows the top plan view of the micromachined fluid ejector array according to a preferred embodiment of present invention. Piezoelectric transducers 16a, 16b, 16c and 16d form concentric rings surrounding the center of fluid ejector array. These piezoelectric transducers can have the same width or different widths. Between neighboring piezoelectric transducers 16, there is a scalable array of orifices 14a, 14b, 14c and 14d drilled on the elastic membrane 13. The diameter of the orifices 14 can be same or different, depending on the particular applications. Orifices 14 are arranged uniformly between neighboring piezoelectric transducers 16.

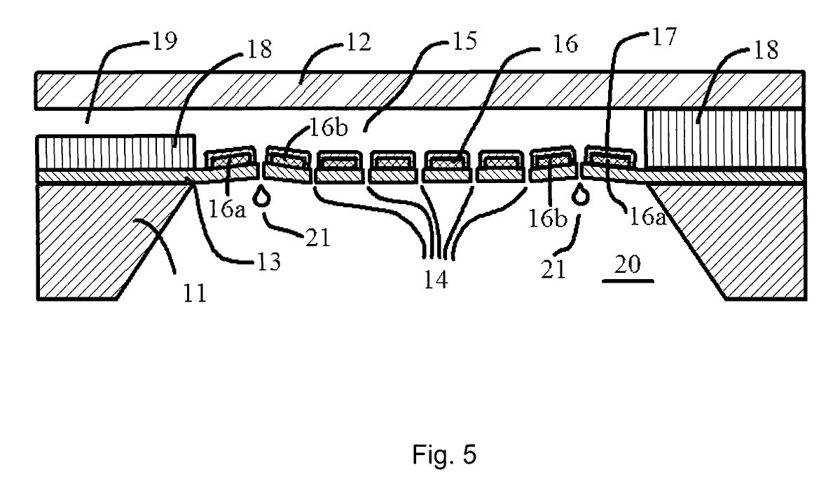

In one mode of operation, as illustrated in FIG. 5, the neighboring piezoelectric transducers 16a and 16b are applied with electric voltage to cause the elastic membrane 13 to deflect up and/or down. The orifices 14a arranged between them will vibrate to eject fluid droplets 21. Similarly, other orifices 14b, and 14c can also be deflected to eject fluid droplets if transducers 16b and 16c, 16c and 16d are actuated, respectively. If all piezoelectric transducers 16 are actuated, all orifices 14 will eject fluid droplets at the same frequency that the piezoelectric transducers 16 are driven. If less than all transducers are actuated, or the actuators are not driven in phase, droplets can be selectively ejected from some orifices, but not others.

It is understood that the examples and embodiments described herein are for illustrative purposes only and that various modifications or changes in light thereof will be suggested to persons skilled in the art and are to be included within the spirit and purview of this application and scope of the appended claims. The foregoing descriptions of specific embodiments of the present invention are presented for the purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A micromachined fluid ejector comprising:
a membrane comprising two or more concentric piezoelectric transducers; and,
two or more orifices through the membrane and positioned between the two or more concentric transducers.

2. The ejector of claim 1, further comprising a fluid reservoir on a first side of the membrane.

3. The ejector of claim 2, wherein the orifices are not isolated from each other by ribs on the first side of the membrane.

4. The ejector of claim 2, further comprising a cover aligned parallel to the membrane and comprising a bulk actuator.

5. The ejector of claim 4, wherein the bulk actuator is selected from the group consisting of: a piezoelectric actuator, a piezoresistive actuator, an electrostatic actuator, a capacitive actuator, a magnetostrictive actuator, a thermal actuator and a pneumatic actuator.

6. The ejector of claim 2, further comprising a fluid in the reservoir.

7. The ejector of claim 6, wherein the fluid comprises an ink, a drug or a fuel.

8. The ejector of claim 2, wherein a second side of the membrane borders a cavity into which the fluid can be ejected from the orifices as droplets.

9. A method of microfluid ejection, the method comprising:
providing a membrane comprising two or more concentric piezoelectric transducers; and comprising two or more orifices positioned between the two or more concentric transducers;
providing a reservoir of fluid on a first side of the membrane; and,
applying an electric voltage to one or more of the transducers;
thereby deflecting one or more nozzles and ejecting one or more droplets of the reservoir fluid from the one or more orifices.

10. The method of claim 9, wherein the electric voltage is applied to the two or more piezoelectric transducers at once.

11. The method of claim 9, wherein the orifices are not isolated from each other by ribs on the first side of the membrane.

12. The method of claim 9, wherein the fluid comprises an ink, a drug or a fuel.

13. The method of claim 9, further comprising:
providing a cover aligned parallel to the membrane and comprising a bulk actuator; and,
actuating the bulk actuator.

14. The method of claim 13, wherein said actuating comprises generation of a bulk actuation wave characterized by an amplitude large enough to eject droplets from the two or more orifices.
